(19) United States
(12) Patent Application Publication
(10) Pub. No.: US 2018/0032960 A1
(43) Pub. Date: Feb. 1, 2018

(54) Methods, Systems, and Computer-Readable Medium Having Computer Program Products Stored Thereon For a Proactive, Bi-Directional Professional Networking Application

(71) Applicant: IS&T CONSULTING GROUP LLC, Houston, TX (US)

(72) Inventor: Donald Anthony Pannagl, Jr., Houston, TX (US)

(73) Assignee: IS&T Consulting Group LLC, Houston, TX (US)

(21) Appl. No.: 15/225,453

(22) Filed: Aug. 1, 2016

(51) Int. Cl. G06Q 10/10

(52) U.S. Cl. CPC G06Q 10/1053

(57) ABSTRACT

Embodiments of the disclosure include methods, systems, and computer-readable media for a bi-directional matching of users in a networking and recruiting system and dual role profiles in the networking and recruiting system. A user of the networking and recruiting system may create a single role profile having a candidate profile or dual role profiles having both a candidate profile and a hiring manager profile. A candidate profile may be an active candidate profile or a passive candidate profile having public data viewable by other users of the networking and recruiting system and private data only viewable after a grant of a permission by the user account associated with the passive candidate profile.

### BACKGROUND

### Field of the Disclosure

Embodiments of the disclosure generally relate to networking and recruiting using computer networks. More specifically, embodiments of the disclosure are directed to bi-directional matching of employment candidates and hiring managers in a networking and recruiting system and dual role profiles in the networking and recruiting system.

### Description of the Related Art

The advent of the Internet and the World Wide Web (WWW) has created new platforms for job seekers and recruiters. For example, a typical candidate for a job may post his or her resume online on a job board. Similarly, a typical recruiter or human resources personnel may post a job opening online on the job board. However, this recruiting model is inefficient as it requires the job candidate to wait for a contact from the recruiter or human resources personnel, the recruiters or human resources personnel to wait for a job candidate to contact them, or both. Moreover, some platforms require a candidate to have a public-facing profile, thus preventing some candidates from posting their information on the job board due to concerns of exposure to their current employer.

### SUMMARY

Embodiments of the disclosure generally relate to a networking and recruiting system, including at least one server having a non-transitory computer-readable memory and a processor, in which the non-transitory computer-readable memory has executable computer code stored thereon. The executable computer code includes instructions to cause the processor to perform the following operations: providing at least one webpage to a user device in response to a request for a webpage, receiving candidate data and candidate skillsets associated with an employment candidate, creating a candidate profile having the candidate data and skillsets, storing the created candidate profile in a profile database, determining, after providing the at least one webpage, a selection of dual role profiles, and upon determining that the selection comprises dual role profiles, perform the following operations: receiving employer data and employer skillsets associated with employment requirements of an employer, creating a hiring manager profile having the employer data and employer skillsets, and storing the created hiring manager profile in a profile database, wherein the created candidate profile and the created hiring manager profile are associated with the same user account.

According to at least one embodiment, the operations further include: selecting a candidate profile, the selected candidate profile having a respective one or more employment candidate skillsets, selecting a hiring manager profile, the hiring manager profile having a respective one or more employer skillsets, determining whether at least one of the one or more employment candidate skillsets of the candidate profile match at least one of the one or more employer skillsets of the hiring manager profile, and associating the candidate profile with the hiring manager profile based on the determination.

According to at least one embodiment, the operations further include: sending a notification to a user account associated with the hiring manager profile based on the determination, the notification identifying the candidate profile.

According to at least one embodiment, the operations further include: selecting a candidate profile having a respective one or more employment candidate skillsets, selecting a hiring manager profile, the hiring manager profile having one or more employer skillsets, identifying a matching threshold associated with the hiring manager profile, the matching threshold defining a minimum number or percentage of skillsets, determining whether at least the minimum number or percentage of the one or more employer skillsets of the candidate profile match the one or more employer skillsets of the hiring manager profile, and associating the candidate profile with the hiring manager profile based on the determination.

According to at least one embodiment, the operations further include: after creating the candidate profile having the candidate data and skillsets, performing the following operations: determining a selection of a passive candidate profile, identifying the created candidate profile as a passive candidate profile, identifying the candidate data as private data of the candidate profile, where the private data is only viewable by another user of the networking and recruiting system upon a grant of permission to another user account by a user account associated with the candidate profile, and storing the candidate skillets as public data of the candidate profile, wherein the public data is viewable by other users of the networking and recruiting system.

According to at least one embodiment, the operations further include: determining that one or more employment candidate skillets of the passive candidate profile matches one or more skillsets of a selected hiring manager profile, and sending a notification to a user account identified with the hiring manager profile based on the determination, the notification comprising the public data of the passive candidate profile or comprising a link to the public data of the passive candidate profile.

According to at least one embodiment, the operations further include: receiving, from the user account identified with the hiring manager profile, a selection to send a request to a user account identified with the passive candidate profile, the request comprising a request to grant permission to view the private data of the passive candidate profile, and sending the request to the user account identified with the passive candidate profile.

According to at least one embodiment, the operations further include: receiving, from the user account identified with the passive candidate profile, a grant of permission to the user account associated with the hiring manage profile to view the private data of the passive candidate profile.

According to another embodiment, there is provided a non-transitory computer-readable media having executable computer code stored thereon, in which the executable computer code includes instructions to cause a processor to perform the following operations: providing at least one webpage to a user device in response to a request for a webpage, receiving candidate data and candidate skillsets associated with an employment candidate, creating a candidate profile having the candidate data and skillsets, storing the created candidate profile in a profile database, determining, after providing the at least one webpage, a selection of dual role profiles, and upon determining that the selection comprises dual role profiles, perform the following operations: receiving employer data and employer skillsets associated with employment requirements of an employer, creating a hiring manager profile having the employer data and employer skillsets, and storing the created hiring manager profile in the profile database, wherein the created candidate profile and the created hiring manager profile are associated with the same user account.

According to at least one embodiment, the operations further include: selecting a candidate profile, the selected candidate profile having a respective one or more employment candidate skillsets, selecting a hiring manager profile, the hiring manager profile having a respective one or more employer skillsets, determining whether at least one of the one or more employment candidate skillsets of the candidate profile match at least one of the one or more employer skillsets of the hiring manager profile, and associating the candidate profile with the hiring manager profile based on the determination.

According to at least one embodiment, the operations further include: sending a notification to a user account associated with the hiring manager profile based on the determination, the notification identifying the candidate profile.

According to at least one embodiment, the operations further include: after creating the candidate profile having the candidate data and skillsets, performing the following operations: determining a selection of a passive candidate profile, identifying the created candidate profile as a passive candidate profile, identifying the candidate data as private data of the candidate profile, where the private data is only viewable by another user of the networking and recruiting system upon a grant of permission to another user account by a user account associated with the candidate profile, and storing the candidate skillets as public data of the candidate profile, wherein the public data is viewable by other users of the networking and recruiting system.

According to at least one embodiment, the operations further include: determining that one or more employment candidate skillets of the passive candidate profile matches one or more skillsets of a selected hiring manager profile, and sending a notification to a user account identified with the hiring manager profile based on the determination, the notification comprising the public data of the passive candidate profile or comprising a link to the public data of the passive candidate profile.

According to at least one embodiment, the operations further include: receiving, from the user account identified with the hiring manager profile, a selection to send a request to a user account identified with the passive candidate profile, the request comprising a request to grant permission to view the private data of the passive candidate profile, and sending the request to the user account identified with the passive candidate profile.

According to at least one embodiment, the operations further include: receiving, from the user account identified with the passive candidate profile, a grant of permission to the user account associated with the hiring manage profile to view the private data of the passive candidate profile.

According to another embodiment, there is provided a networking and recruiting system including at least one server having a non-transitory computer-readable memory and a processor, in which the non-transitory computer-readable memory has executable computer code stored thereon. The executable computer code includes instructions to cause the processor to perform the following operations: providing at least one webpage to a user device in response to a request for a webpage, receiving candidate data and candidate skillsets associated with an employment candidate, creating a candidate profile having the candidate data and skillsets, storing the created candidate profile in a profile database, determining, after providing the at least one webpage, a selection of dual role profiles, and upon determining that the selection comprises dual role profiles, perform the following operations: receiving employer data and employer skillsets associated with employment requirements of an employer, creating a hiring manager profile having the employer data and employer skillsets, and storing the created hiring manager profile in the profile database, wherein the created candidate profile and the created hiring manager profile are associated with the same user account.

According to at least one embodiment, the operations further include: determining a selection of the first candidate profile as a passive candidate profile, identifying the first candidate data as private data of the first candidate profile, where the private data is only viewable by another user of the networking and recruiting system upon a grant of permission to another user account by the first user account, and storing the candidate skillets as public data of the first candidate profile, wherein the public data is viewable by other users of the networking and recruiting system.

According to at least one embodiment, the operations further include: determining that employment candidate skillets of the passive candidate profile match employer skillsets of a selected hiring manager profile, and sending a notification to a third user account identified with the selected hiring manager profile based on the determination, the notification comprising the public data of the passive candidate profile or a link to the public data of the passive candidate profile.

According to at least one embodiment, the operations further include: receiving, from the third user account, a selection to send a request to the first user account, the request comprising a request to grant permission to view the private data of the passive candidate profile, and sending the request to the first user account.

According to at least one embodiment, the operations further include: receiving, from the first user account, a grant of permission to the third user account associated to view the private data of the passive candidate profile.

### BRIEF DESCRIPTION OF THE DRAWINGS

FIG. 1 is a schematic diagram depicting interaction between a job candidate user, a hiring manager user, and a job platform in accordance with an embodiment of the disclosure.

FIG. 2 is a block diagram of a process for selecting single role or dual role profiles in accordance with an embodiment of the disclosure.

FIG. 3 is a block diagram of a process for creating a candidate profile in accordance with an embodiment of the disclosure.

FIG. 4 is a block diagram of a process for creating a hiring manager profile in accordance with an embodiment of the disclosure.

FIGS. 5A and 5B are block diagrams of a process for bi-directional matching between a hiring manager profile and candidate profiles in accordance with an embodiment of the disclosure.

FIG. 6 is a block diagram depicting bi-directional matching between candidate profiles and hiring manager profiles by a matching engine in accordance with an embodiment of the disclosure.

FIG. 7 is a block diagram of a computing resource environment in accordance with an embodiment of the disclosure.

### DETAILED DESCRIPTION

The present disclosure will now be described more fully hereinafter with reference to the accompanying drawings, which illustrate embodiments of the disclosure. This disclosure may, however, be embodied in many different forms and should not be construed as limited to the illustrated embodiments set forth herein. Rather, these embodiments are provided so that this disclosure will be thorough and complete, and will fully convey the scope of the disclosure to those skilled in the art.

Embodiments of the disclosure include methods, systems, and computer-readable media for a bi-directional matching of users in a networking and recruiting system and dual role profiles in the networking and recruiting system. In some embodiments, a networking and recruiting system includes a web portal that enables users to access webpages for creation of candidate profiles and hiring manager profiles. A user may create a candidate profile having candidate data (e.g., biographical data, such as name, address, contact data, and the like) and employment candidate skillsets associated with the user. In some embodiments, after creation of a candidate profile, a user may additionally create a hiring manager user having employer data (e.g., the name of the employer, the locations of the employer, the type of employer, and other employer data) and employer skillsets the hiring manager or employer is seeking in potential employment candidates.

In some embodiments, a candidate profile may be an active candidate profile or a passive candidate profile. Upon creation of a candidate profile, a user may decide to create an active candidate profile or a passive candidate profile. An active candidate profile may be viewable by other users of the networking and recruiting system, such that all data of the candidate profile is public data. A passive candidate profile may include public data viewable by other users of the job platform and private data (e.g., a user's identity) only viewable after a grant of permission by the user associated with the passive candidate profile.

In some embodiments, a user of the networking and recruiting system may create a single role profile or dual role profiles. For example, a user of the networking and recruiting system may select a single role profile and create a candidate profile. Alternatively, a user of the networking and recruiting system may select dual role profiles and create a candidate profile and, additionally, a hiring manager profile.

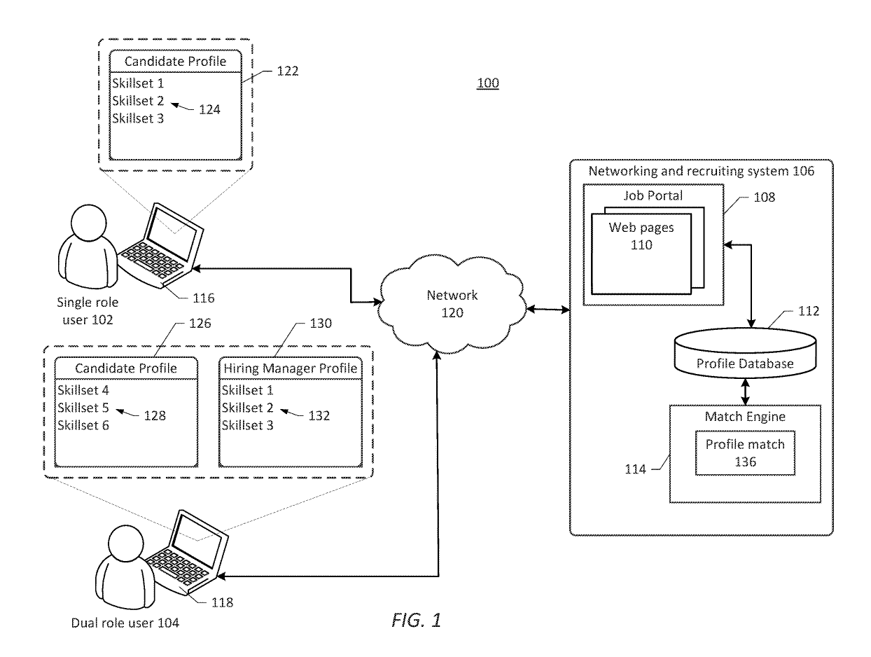

FIG. 1 depicts a schematic diagram 100 showing the interaction between a single role user 102, a dual role dual role user 104, and a networking and recruiting system 106 in accordance with an embodiment of the disclosure. As shown in FIG. 1, the networking and recruiting system 106 may include a job portal 108 that serves webpages 110 to requesting devices, a profile database 112, and a match engine 114. In some embodiments, the job portal 108 may be implemented in a computing resource environment (e.g., a “cloud” computing platform, but not limited thereto) having physical or virtual computing resources. The computing resource environment may include a single server or multiple servers (e.g., in a discrete physical server or as a virtual server). Such servers may include web servers (e.g., servers configured to receive requests for webpages and serve webpages in response to the request), application servers, database servers, or other types of servers, as non-limiting examples. Additionally, such servers may be, for example, computers arranged in any physical and virtual configuration, such as computers in one or more data processing centers, a distributed computing environment, or other configuration. Such configurations may use the network 120 depicted in FIG. 1 for communication or may communicate over other networks.

According to at least one embodiment, the single role user 102 may interact with the networking and recruiting system 106 via a user device 116. Similarly, the dual role user 104 may interact with the networking and recruiting system 106 via a user device 118. The user devices 116 and 118 and the networking and recruiting system 106 may communicate over the network 120, such as the Internet. In some embodiments, for example, a user device may access the job portal 108 via webpages 110. The user devices 116 and 118 may each include, for example, a desktop computer, a laptop computer, a tablet computer, a smartphone, or other user device capable of requesting and receiving webpages 110 (such as via a web browser executing on the user device). As will be appreciated, in some embodiments the job portal 108 may serve a webpage requesting login credentials associated with a user account created on and stored by the networking and recruiting system 106. Such login credentials may include, for example, a user name and a password (or additional or alternative authentication credentials). Thus, the single role user 102 may access the networking and recruiting system 106 via a user account associated with the single role user 102. Similarly, the dual role user 104 may access the networking and recruiting system 106 via a user account associated with the dual role user 104.

In some embodiments, a user may create a single role profile, such that the user account associated with the user is identified with a candidate profile. As shown in FIG. 1, for example, the single role user 102 may be an employment candidate and may create a candidate profile 122 via the job portal 106. The candidate profile 122 may include information about the single role user 102 (e.g., biographical data such as name, address, contact data, and the like). The candidate profile 122 may also include a list and description of employment candidate skillsets and job history associated with the single role user 102. The employment candidate skillsets and job history may include functional skillsets and technical skillsets, which are aggregated into a master functional and technical skillset listing. For example, the candidate profile 122 may include skillsets 124, such as Skillset 1, Skillset 2, and Skillset 3. The single role profile, e.g., the candidate profile 122, may be identified with the user account of the single role user, such as by associating the candidate profile with a user identifier associated with the user account. In some embodiments, as described further below, a candidate profile may be a passive candidate profile having private data that is only accessible to other users of the job platform via grant of permission by the user account identified with the passive candidate profile.

In some embodiments, a user may create dual role profiles, such that the user account associated with the user is identified with dual profiles: a candidate profile and a hiring manager profile. Advantageously, the dual role profiles enable a user to create a candidate profile to make themselves available as an employment candidate and, subsequently, to create a hiring manager profile to look for employment candidates for employment positions. As shown in FIG. 1, for example, the dual role user 104 may be create a candidate profile 126 and, after creation of the candidate profile 126, may create a hiring manager profile 130. For example, the candidate profile 126 may include the employment candidate skillsets 128 of the dual role user 104, such as Skillset 4, Skillset 5, and Skillset 6.

The dual role user 104 may also create the hiring manager profile 130, if the dual role user 104 desires to search for employment candidates using the matching functionality provided by the networking and recruiting system 106. For example, the hiring manager profile 130 may include skillsets that fulfill one or more requirements for employment positions identified by the user 104 or user employer and for which employment are desired. For example, the hiring manager profile 130 may include employer skillsets 132, such as Skillset 1, Skillset 2, and Skillset 3. The dual role profiles, e.g., the candidate profile 126 and the hiring manager profile 130, may be identified with the user account of the dual role user 104, such as by associating both the candidate profile 126 and the hiring manager profile 130 with a user identifier associated with the user account. As mentioned above, a candidate profile may be a passive candidate profile having private data, thus enabling the dual role user 104 to make their employment information anonymously available in the networking and recruiting system 106. That is, the dual role use 104 may make the candidate profile 126 associated with user 104 a passive candidate profile available in the system 106 without revealing their identity to other users of the system 106. In some embodiments, the creation of the hiring manager profile 130 may enable another user or user account to use the hiring manager profile by proxy for a time period. For example, the hiring manager profile 130 may be associated with a set time period for enabling use by another user or user account.

The profiles 122, 126, and 130 may be created via selections and inputs entered via the webpages 110 of the job portal 108 and may be stored in the profile database 112. After creation of a profile, the match engine 114 may perform matching between candidate profiles and hiring manager profiles. For example, because the candidate profile 122 includes the three skillsets, Skillset 1, Skillset 2, and Skillset 3 and the hiring manager profile 130 also includes the three functional and technical skillsets, Skillset 1, Skillset 2, and Skillset 3 (i.e., three skillsets that the hiring manager profile is seeking), a profile match 136 may be determined between the candidate profile 122 and the hiring manager profile 130. In such instances, as described further below, a notification may be sent to the dual role user 104 indicating that a candidate profile matches the hiring manager profile 130 associated with the dual role user 104 and an employer. In such instances, the dual role user 104 may then initiate contact with the single role user 102 via the job portal 106.

According to at least one embodiment, the matching is performed instantaneously/automatically (i.e., creating a dynamic system). For example, the dual role user 104 may use the job portal 108 to initiate a request for matching of candidate profiles with the hiring manager profile 130. In some embodiments, the matching may be dynamically performed in response to the fulfillment of other criteria, such as a change in a hiring manager profile, a change in a candidate profile, the creation of a specific number of new candidate profiles, or other suitable criteria. For example, the matching may be performed after the dual role user 104 modifies the hiring manager profile 130, such as by adding a skillset, removing a skillset, editing a skillset, and so on.

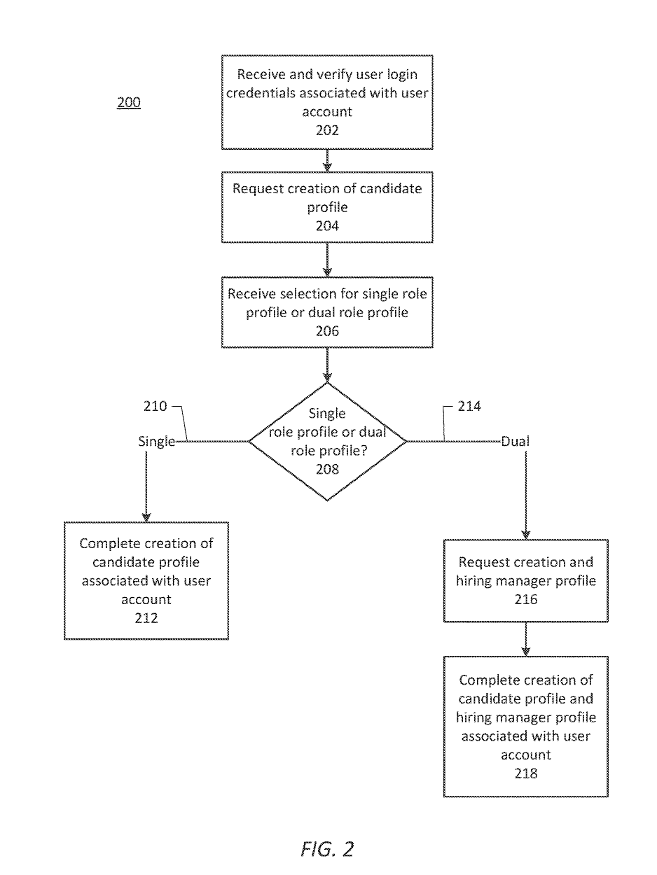

FIG. 2 depicts a process 200 illustrating selection of single role or dual role profiles in accordance with an embodiment of the disclosure. Portions of the process 200 may be implemented using webpages 110 of the job portal 108 of the networking and recruiting system 106. For example, webpages 110 may include a form for receiving user input related to a candidate profile, such as input relating to biographical data, contact data, and skillsets, as non-limiting examples. Initially, as shown in FIG. 2, user login credentials associated with a user account of the networking and recruiting system 106 may be received and verified (block 202). For example, a user device may request a login webpage from the job portal 108 and receive a login webpage having fields for entry of login credentials, such as a user name and password.

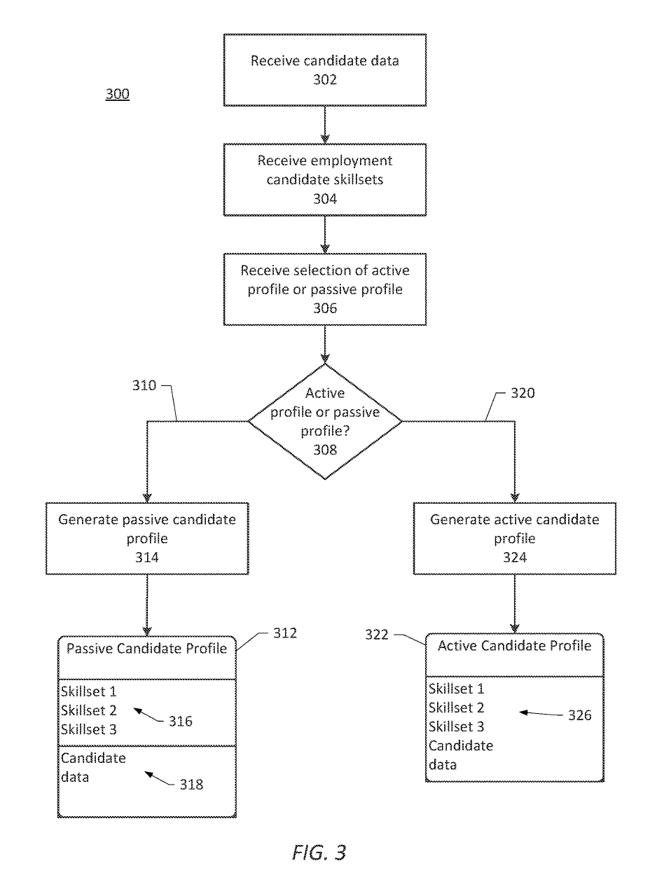

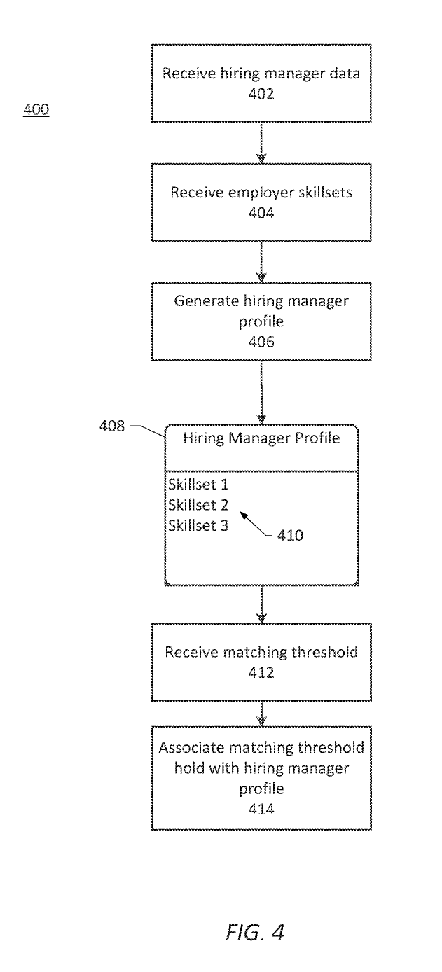

After user login credentials are received and verified, creation of a candidate profile may be requested (block 204). The creation of a candidate profile is described further below with reference to FIG. 3. Next, a selection of a single role profile or dual role profiles may be received from the user (block 206). For example, a webpage of the job portal 108 may be provided with instructions and a user interface element, such as a radio button or dropdown, enabling selection of a single role profile or dual role profiles. In some embodiments, a webpage of the job portal 108 may with instructions and a user interface element requesting whether the user wants to additionally create a hiring manager profile. The user's selection determines whether the profile creation will include a single profile or dual profile (decision block 208). If a single role profile is selected (line 210), the creation of the candidate profile associated with the user account may be completed (block 212). If a dual role profile is selected (line 214), then creation of a hiring manager profile may be requested (block 216) For example, as mentioned above, a user account of the networking and recruiting system may belong to a user who is both an employment candidate for employment positions, but is also a hiring manager for an employer. Thus, after creation of a candidate profile, such a user may create a hiring manager profile to facilitate identification and evaluation of employment candidates via candidate profiles of the networking and recruiting system 106. The creation of a hiring manager profile is described further below with reference to FIG. 4. Next, the creation of the candidate profile associated with the user account and the hiring manager profile associated with the user account may be completed (block 218).

FIG. 3 depicts a process 300 for creation of a candidate profile in accordance with an embodiment of the disclosure. As described herein, a candidate profile may be an active candidate profile having public data viewable by other users of the networking and recruiting system 106 or a passive candidate profile having private data only viewable after a grant of permission from the user account associated with the passive candidate profile. In some embodiments, a passive candidate profile may have both public data viewable by other users of the networking and recruiting system 106 and private information only viewable after a grant of a permission by the user account associated with the passive candidate profile.

Initially, as shown in FIG. 3, candidate data may be received (block 302). Such information may include biographical data, such as name, and address, contact data, and other suitable candidate data. Next, in some embodiments, employment candidate skillsets may be received (block 304). For example, in some embodiments user interface elements may be provided on a webpage of the job portal 108 to accept user input identifying skillsets. Such skillsets may include technical skillsets, functional skillsets or both, as non-limiting examples. In some embodiments, a skillset may include a level associated with the skillset, years of experience associated with the skillset, certifications associated with the skillset, and other suitable proficiency indications of a skillset and combinations thereof, as non-limiting examples.

In some embodiments, a selection of an active candidate profile or passive candidate profile may be received (block 306) and different profiles may be generated based on whether an active candidate profile or passive candidate profile is selected (decision block 308). For example, if the passive candidate profile is selected (line 310), a passive candidate profile 312 may be generated (block 314). In some embodiments, the passive candidate profile 312 may include public data 316 viewable by other users of the networking and recruiting system 106 and private data 318 only viewable after a grant of a permission by the user account associated with the passive candidate profile. For example, the candidate data input by a user may be identified as private data of the passive candidate profile 314. In some embodiments, the employment skillsets input by a user may be identified as public data of the passive candidate profile 314. Thus, when the passive candidate profile 314 is matched with a hiring manager profile, for example, a hiring manager user may be able to view the public data (skillsets) while being unable to view the private date (e.g., the identity of the user). In some embodiments, the private data 318 may only include the identity of the user associated with the passive candidate profile 312. In other embodiments, the private data 318 may include additional information, such as current employer, previous employers, etc.

If an active candidate profile is selected (line 320), then an active candidate profile 322 may be generated (block 324). In some embodiments, all data associated with the active candidate profile 322 may be public data 326 such that the data is viewable by other users of the networking and recruiting system 106. For example, the public data 326 of the active candidate profile 322 may include candidate data and skillsets, as non-limiting examples. Thus, when the active candidate profile 322 is matched with a hiring manager profile, for example, a hiring manager user may be able to view both the candidate data and the skillsets of the active candidate profile 322.

In some embodiments, a passive candidate profile may be changed to an active candidate profile. For example, in some embodiments, the job portal may provide a user interface element that enables changing a passive candidate profile to an active candidate profile, or changing an active candidate profile to a passive candidate profile. In such embodiments, when a passive candidate profile is changed to an active candidate profile, the private data (such as candidate data) of the passive candidate profile may be changed to public data of the active candidate profile, such that the formerly private data becomes public data viewable by other users of the networking and recruiting system 106. In such embodiments, when an active candidate profile is changed to a passive candidate profile, some of the public data (such as candidate data) of the active candidate profile may be changed to private data of the passive candidate profile, such that the formerly public data becomes private data not viewable by other users of the job platform unless a specific user account is granted permission by the user account associated with the passive candidate profile.

FIG. 4 depicts a process 400 for creation of a hiring manager profile in accordance with an embodiment of the disclosure. Initially, hiring manager data may be received (block 402). Such data may include employer data, such as the name of the employer, the locations of the employer, the type of employer, and other employer data. In some embodiments, the hiring manager information may include the name of the hiring manager and contact data for the hiring manager. Next, in some embodiments, employer skillsets for employment positions the hiring manager is seeking may be received (block 404). For example, in some embodiments user interface elements may be provided on a webpage of the job portal 108 to accept user input identifying employer skillsets. Such skillsets may include technical skillsets, functional skillsets or both, as non-limiting examples. In some embodiments, a skillset may include a level associated with the skillset, years of experience associated with the skillset, certifications associated with the skillset, and other suitable proficiency indications of a skillset and combinations thereof, as non-limiting examples. In some embodiments, a hiring manager profile associated with a user account may be created based on a candidate profile associated with the user account. For example, when creation of a hiring manager profile is requested, a hiring manger profile may be created that includes some or all of the skillsets of the candidate profile associated with the same user account. In some embodiments, an authorization to enable one or more other users or user accounts to use the hiring manger profile may be received and associated with the created hiring manager profile. In some embodiments, a time period associated with the authorization may be received and associated with the created hiring manager profile, such that the hiring manager profile 130 may authorized for use by other users or user accounts only for the set time period.

A hiring manager profile 408 may then be generated (block 406). In some embodiments, all data associated with the hiring manager profile 408 may be public data 410, such that the data is viewable by other users of the job platform. For example, the public data of the hiring manager profile 408 may include employer data and employer skillsets, as non-limiting examples. Thus, when the hiring manager profile is matched with a candidate profile, for example, a candidate user may be able to view both the employer data and the employer skillsets of the hiring manager profile 408. In some embodiments, the hiring manager profile 408 may include public data viewable by other users of the networking and recruiting system 106 and private data only viewable after a grant of a permission by the user account associated with the hiring manager profile. In some embodiments, the employer skillsets input by a user may be identified as public data of the hiring manager profile 408, so that when the hiring manager profile 408 is matched with a candidate profile, a candidate user may be able to view the public data (e.g., skillsets) while being unable to view the private data (e.g., the identity of the user associated with the profile).

In some embodiments, a matching threshold for the hiring manager profile may be requested (block 412), and the matching threshold may be associated with the hiring manager profile (block 414). For example, in some embodiments the job portal 108 may include a webpage having a user interface element that receives, as input, a numerical value specifying the matching threshold. The matching threshold may define a minimum number or percentage of mutual skillsets between a candidate profile and a hiring manager profile before the candidate profile is considered a match with the hiring manager profile. For example, if the matching threshold associated with a hiring manager profile is set at 75%, then at least 75% of the skillsets associated with the hiring manager profile must match the skillsets of a candidate profile. In this example, if the hiring manager profile includes four skillets, then at least three of the four skillets must match the skillsets of a candidate profile for the candidate profile to be identified as a match with the hiring manager profile.

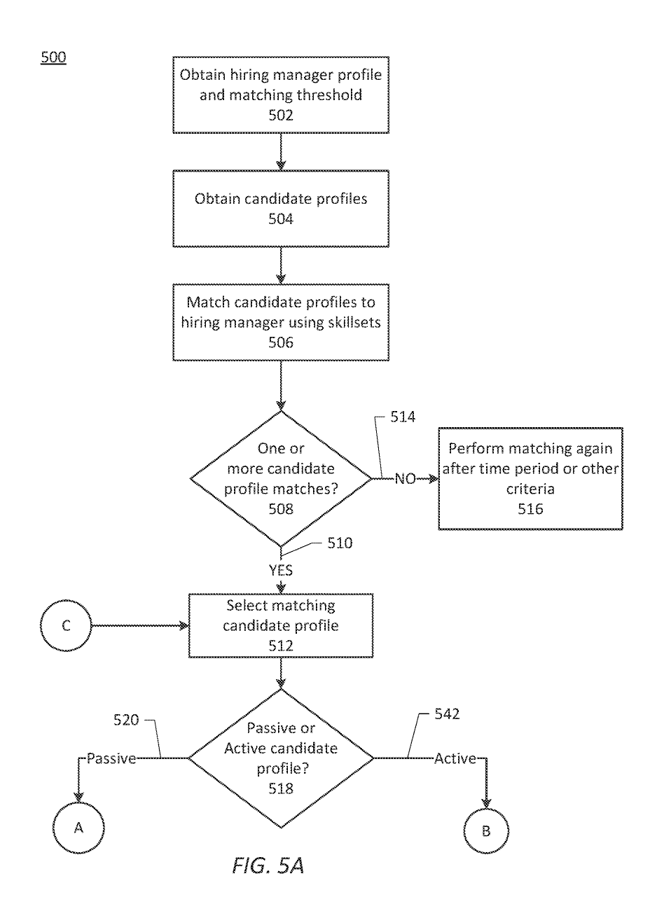

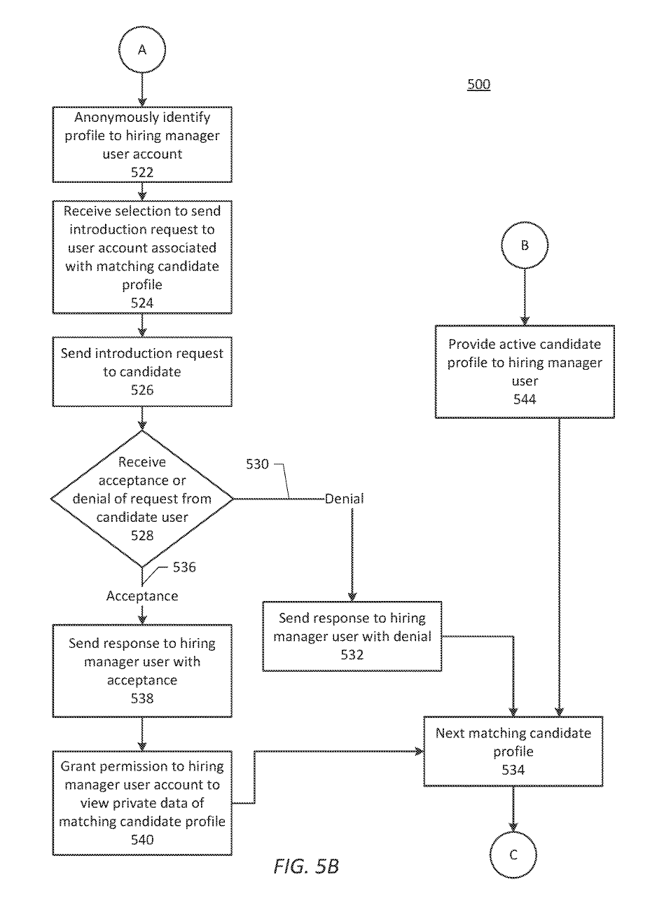

FIGS. 5A and 5B depict a process 500 for bi-directional matching between a hiring manager profile and candidate profiles in accordance with an embodiment of the disclosure. In some embodiments, as described below, the process 500 is performed instantaneously/automatically. In some embodiments, the matching may be performed upon request by a user, such as hiring manager user associated with a hiring manager profile. In some embodiments, the matching may be performed in response to the fulfillment of other criteria, such as a change in a hiring manager profile, the creation of a specific number of new candidate profiles, or other suitable criteria. In some embodiments, the bi-directional matching between hiring manager profiles and candidate profiles may generate a dynamic professional network, such that any changes to a hiring manager profile or a candidate profile (e.g., a change in skillsets) may dynamically change the associations based on the change. For example, a change in the skillsets of a candidate profile may dynamically change the hiring manager profiles associated with that candidate profile. In some embodiments, a candidate profile may have dynamic non-permanent associations with one or more hiring manager profiles and permanent associations with hiring manger profiles. For example, in some embodiments, dynamic non-permanent associations may include those associations generated by the bi-directional matching process described herein. In some embodiments, permanent associations may include an association between a candidate profile and a hiring manager profile that has been manually confirmed or created by a user account associated with the candidate profile.

Initially, as shown in FIG. 5, a hiring manager profile and, if present, a matching threshold associated with the hiring manager may be obtained (block 502). For example, a hiring manager profile having employer skillsets and other data may be obtained from the profile database 112. Next, candidate profiles may be obtained (block 504), such as from the profile database 112 or another database. In some embodiments, for example, candidate profiles may be filtered before matching with an obtained hiring manager profile. In some embodiments, the filtering may be performed based on preferences associated with a hiring manager user or a hiring manager profile. Such preferences may include, for example, whether the candidate profiles should include active candidate profiles, passive candidate profiles or both, a minimum number of skillsets of a candidate profile, a maximum number of skillsets of a candidate profile, geographical location or preference of the hiring manager or candidate, or other suitable preferences.

Next, selected candidate profiles and the hiring manager profile may be matched using the skillsets of the profiles and, if available, a matching threshold (block 506), so that one or more candidate profile matches may be determined (decision block 508). For example, as described above, the matching threshold may determine the minimum number or percentage of mutual skillsets between a candidate profile and a hiring manager profile for the candidate profile to be identified as a match with the hiring manager profile. In some embodiments, a user identifier associated with a candidate profile may be compared to a user identifier of a hiring manager profile to ensure that two profiles from the same user are not matched.

If one or more candidate profiles match the hiring manager profile (line 510), a matching candidate profile may be selected (block 512) for further processing. In some embodiments, a notification may be sent to the user account identified with the hiring manager profile indicating that at least one candidate profile matches the hiring manager profile. In some embodiments, the notification, the candidate profile matches, or both may be provided in a webpage of the job portal 108. In some embodiments, for example, the notification, the candidate profile matches, or both may be asynchronously provided in a webpage while the user is accessing the job portal 108. In some embodiments, a notification may be sent to portable user device associated with the hiring manager user. For example, the notification may be transmitted via email, text messaging (e.g., short message service (SMS) messaging), instant messaging, or using other types of communication.

If one or more candidate profiles do not match the hiring manager profile (line 514), then the matching is instantaneously/automatically performed again (block 516). In some embodiments, such other criteria may include a change in a hiring manager profile, the generation of a minimum number of new candidate profiles, a change in a minimum number of candidate profiles, a change in preferences associated with a hiring manager user or a hiring manager profile, and so on. In some embodiments, a notification may be sent to the user account identified with the hiring manager profile indicating that no candidate profiles match the hiring manager profile. The notification may thus enable the hiring manager user to decide whether to modify a hiring manager profile, request that the process 500 be performed again, or perform another action. In some embodiments, the notification may be provided in a webpage of the job portal 108. In some embodiments, for example, the notification may be asynchronously provided in a webpage while the user is accessing the job portal 108. In some embodiments, a notification may be sent to portable user device associated with the hiring manager user. For example, the notification may be transmitted via email, text messaging (e.g., short message service (SMS) messaging), instant messaging, or using other types of communication.

After a matching candidate profile is selected (block 512), that matching profile is determined to be a passive candidate profile or an active candidate profile (decision block 518). If the candidate profile is a passive candidate profile (line 520), the candidate profile may be anonymously identified to the hiring manager user account (block 522), i.e., the user account associated with the matching hiring manager profile. A selection to send an introduction request to the user account associated with the identified candidate profile may be received from the hiring manager user (block 524), and an introduction request may be sent to the user account associated with the matching candidate profile (block 526). In some embodiments, the introduction request may be provided in a webpage of the job portal 108. In some embodiments, for example, the introduction request may be asynchronously provided in a webpage while a candidate user is accessing the job portal 108. In some embodiments, an introduction request may be sent to portable user device associated with the user account associated with the passive candidate profile. For example, the introduction request may be transmitted via email, text messaging (e.g., short message service (SMS) messaging), instant messaging, or using other types of communication. In some embodiments, the introduction request may include a hyperlink that enables a candidate user to grant permission to the hiring manager user account to accept the introduction request and grant permission for their passive candidate profile to be viewed by the requesting user account. In some embodiments, the introduction request may be presented as a user interface element, such as a radio button, dropdown box, or other suitable user interface element, that enables a candidate user to accept an introduction request and grant permission for their passive candidate profile to be viewed by the requesting user account. In some embodiments, a webpage of the job portal 108 may include a summarization of all pending introduction requests and may enable a candidate user associated with a passive candidate profile to simultaneously accept multiple introduction requests.

A candidate user may receive the introduction request and choose to accept or deny the introduction request (decision block 528). If the candidate user denies the introduction request (line 530), a response may be sent to the requesting user account indicating a denial of the introduction request (block 532) and the next matched candidate profile may be selected (block 534), as further indicated by connection block C.

If the candidate user accepts the introduction request (line 536), a response may be send to the requesting user account identified with the hiring manager profile indicating an acceptance of the introduction request (block 538), and the a permission to view the private data of the candidate profile may be granted to the requesting hiring manager user account (block 540). The hiring manager may thus be able to view the private data, such as the identity of the user associated with the candidate profile. For example in some embodiments, in some embodiments, the private data may be asynchronously provided in a webpage of the job portal 108, such as by updating an existing displayed passive candidate profile. In some embodiments, the private data of a passive candidate profile may be sent to a user device associated with the hiring manager user, such as via email, short message service (SMS) messaging, instant messaging, or via other suitable messaging technologies. In some embodiments, the private data of a passive candidate profile may be provided after a notification sent to the hiring manager user that the introduction request has been accepted and the private data is now viewable. For example, such a notification may include a hyperlink, such that a hiring manager user may select the hyperlink to view the private data of a passive candidate profile, such as in a webpage of the job portal 108. The next matched candidate profile may then be selected (block 534), as further indicated by connection block C.

As shown in FIGS. 5A and 5B, if the candidate profile is an active candidate profile (line 542), the active candidate profile may be provided to the hiring manager user (block 544), as further indicated by connection block B. The next matched candidate profile may then be selected (block 534), as further indicated by connection block C. In some embodiments, a matching active candidate profile may be instantaneously/automatically provided to a hiring manager user or provided after an action by the hiring manager user. For example, in some embodiments a matching active candidate profile may be asynchronously provided in a webpage of the job portal 108. In some embodiments, a matching active candidate profile may be sent to a user device associated with the hiring manager user account, such as via email, short message service (SMS) messaging, instant messaging, or via other suitable messaging technologies. In some embodiments, a matching active candidate profile may be provided to the hiring manager user after an action by the hiring manager user. For example, a notification of one or more matching candidate profiles may include a hyperlink, such that a hiring manager user may select the hyperlink to receive one or more active candidate profiles, such as in a webpage of the job portal 108.

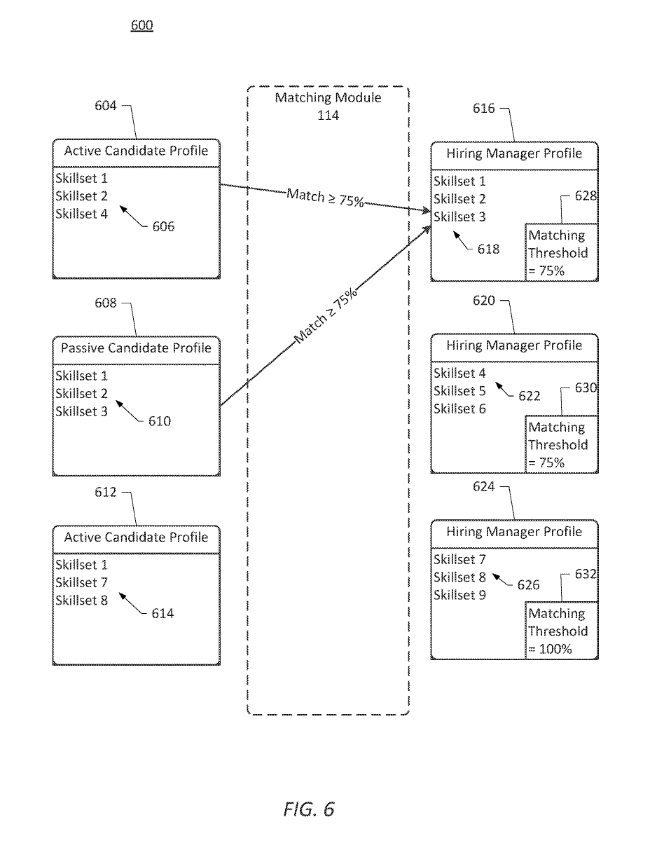

FIG. 6 is a block diagram 600 depicting bi-directional matching between candidate profiles and hiring manager profiles by the matching module 114 in accordance with an embodiment of the disclosure. FIG. 6 depicts an active candidate profile 604 having skillsets 606, a passive candidate profile 608 having skillsets 610, and an active candidate profile 612 having skillsets 614. FIG. 6 also depicts a hiring manager profile 616 having skillsets 618, a second hiring manager profile 620 having skillsets 622, and a third hiring manager profile 624 having skillsets 626. In some embodiments, the profiles may be stored in a database, such as the profile database 112, and data of each profile may be retrieved from the database. In some embodiments, as also noted above, each profile may be associated with a user identifier.

As mentioned above, in some embodiments the hiring manager profiles may be associated with a matching threshold that identifies the number of matching skillets in a candidate profile to be considered a match with the hiring manager profile. For example, the hiring manager profile 616 may be associated with a matching threshold 628 of 75%, the hiring manager profile 620 may be associated with a matching threshold 630 of 75%, and the hiring manager profile 624 may be associated with a matching threshold 632 of 100%.

The matching engine 114 may match candidate profiles to the hiring manager profiles by considering the skillsets and the matching threshold. For example, the passive candidate profile 608 may be matched to the first hiring manager profile 616, as all three skillets (e.g., Skillset 1, Skillset 2, and Skillset 3) of the passive candidate profile 608 match all three skillsets (e.g., Skillset 1, Skillset 2, and Skillset 3) of the hiring manager profile 616. Thus, the skillset match between the passive candidate profile 608 and the hiring manager profile 616 is greater than the matching threshold of 75%. In another example, the active candidate profile 604 may be matched to the first hiring manager profile 616, as two skillsets (e.g., Skillset 1 and Skillset 2) of the active candidate profile 604 match two skillsets (e.g., Skillset 1 and Skillset 2) of the hiring manager profile 616. Thus, the skillset match between active candidate profile 604 and the first hiring manager profile 616 is equal to or greater than the matching threshold of 75%.

As shown in FIG. 6, the second hiring manager profile 620 may not be matched with any candidate profiles. Although the active candidate profile 604 includes one skillset (e.g. Skillset 4) that matches one skillet of the hiring manager profile 620, the match does not meet the matching threshold 630 associated with the hiring manager profile 620. In another example shown in FIG. 6, the third hiring manager profile 624 may not be matched with any candidate profiles. For example, although the active candidate profile 612 includes two skillsets (e.g., Skillset 7 and Skillset 8) that match two skillets of the hiring manager profile 624, the match does not meet the matching threshold 632 associated with the hiring manager profile 624. For example, the matching threshold 632 of 100% associated with the hiring manager profile 624 would require 100% of the skillsets of the hiring manager profile 624 to match 100% of the skillsets of an active candidate profile 612.

In some embodiments, as described above, candidate profiles and hiring manager profiles may be associated with a user identifier. In some embodiments, the matching engine 114 may compare a user identifier of a candidate profile to a user identifier of a hiring manager profile to determine whether the candidate profile and hiring manager profile are associated with the same user (i.e., dual role profiles as described above). Thus, the matching engine 114 may provide for a user to have dual role profiles, e.g., a candidate profile and a hiring manager profile, as described herein.

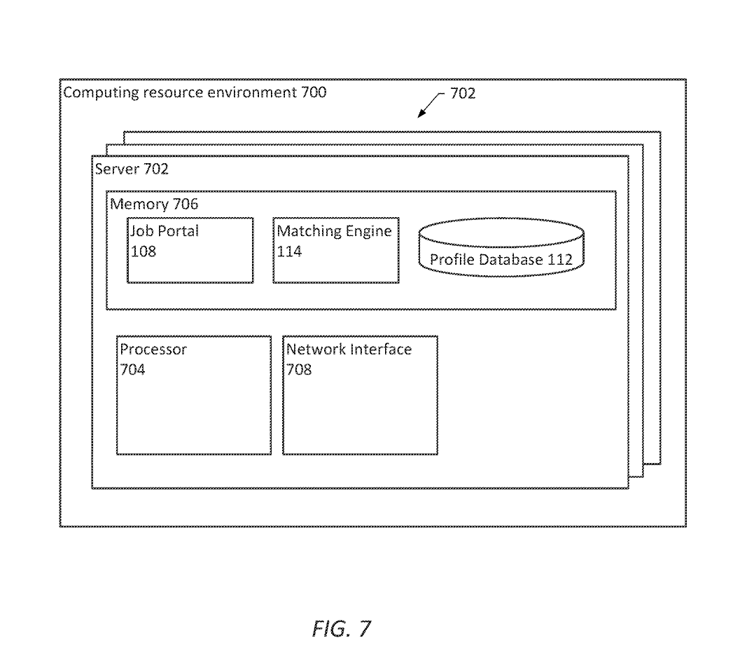

FIG. 7 depicts an example of a computing resource environment 700 that executes the networking and recruiting system 106 in accordance with an embodiment of the disclosure. The computing resource environment 700 may provide a variety of resources to facilitate the processing and storage of data, such as implemented in the networking and recruiting system 106. The resources provided by the computing resource environment 700 may be made accessed via a network, such as the Internet, an intranet, or other suitable networks.

The computing resource environment 700 may provide various computing resources. The resources may include, for example, one or more physical or virtual servers 702. In some embodiments, additional resources may be provided in addition to, or as an alternative to, the resources explicitly described. The servers 702 may include components to facilitate execution of the networking and recruiting system 106. An example of the servers 702 may include a processor 704 (e.g., one or more processors), a memory 706, and a network interface 708.

The processor 704 (as used the disclosure, the term “processor” encompasses microprocessors) may include one or more processors having the capability to transfer data with other components of the example server 702, execute instructions, and perform operations. In some embodiments, the processor 704 may include a reduced instruction set (RISC) processor. Additionally, the processor 704 may include single-core processors and multicore processors and may include graphics processors. In some embodiments, multiple processors, or single or multiple processors of multiple servers, may be employed to provide for parallel or sequential execution of one or more of the techniques described in the disclosure. The processor 704 may receive instructions and data from a memory (for example, memory 706).

The memory 706 (which may include one or more non-transitory computer readable storage medium) may include volatile memory, such as random access memory (RAM), and non-volatile memory, such as ROM, flash memory, a hard drive, any other suitable optical, magnetic, or solid-state storage medium, or a combination thereof. The memory 706 may be accessible by the processor 704 and, in some embodiments, other components of the example server 702. The memory 706 may store executable computer code, such as an operating system for the example server 702, and other executable code. The executable computer code may include computer program instructions for implementing one or more techniques described in the disclosure, For example, the executable computer code may include the networking and recruiting system 106 and the matching engine 110 executable by a processor (e.g., the processor 704) to implement one or more embodiments of the present disclosure. In some embodiments, the memory 706 may implement databases or other data collections for implementing one or more techniques described in the disclosure. For example, the memory 706 may store the profile database 112 accessible by the processor 704 to implement one or more embodiments of the present disclosure. In some embodiments, for example, the processor 704 may determine a candidate profile or a hiring manager profile and store the determined profile or profiles in profile database 112 in the memory 706. In some embodiments, the executable computer code may implement one or more elements of process 200 described above and illustrated in FIG. 2, process 300 described above and illustrated in FIG. 3, process 400 described above and illustrated in FIG. 4, and process 500 described above and illustrated in FIGS. 5A and 5B.

As previously mentioned, the memory 706 may include volatile memory, such as random access memory (RAM). The memory 706 may also include non-volatile memory, such as ROM, flash memory, a hard drive, any other suitable optical, magnetic, or solid-state storage medium, or a combination thereof. In some embodiments, the processor 702, memory 706, and one or more other components of the example server 702 may be implemented on a single chip, such as a system-on-a-chip (SOC). In other embodiments, these components, their functionalities, or both may be implemented on separate chips.

The example server 702 may also include the network interface 708 to enable communication over one or more communication networks. The network interface 708 may include a wired network interface (e.g., a network interface card (NIC)), a wireless (e.g., radio frequency) network interface card, or combination thereof. The network interface 708 may include circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 708 may communicate with networks, such as the Internet, an intranet, a cellular telephone network, a wide area network (WAN), a local area network (LAN), a metropolitan area network (MAN), or other devices by wired or wireless communication. The communication may use suitable communications standard, protocol and technology, including Ethernet, Wireless Fidelity (Wi-Fi) (e.g., IEEE 802.11 standards), an email protocol (e.g., Internet message access protocol (IMAP) or post office protocol (POP)), message-oriented protocols (e.g., extensible messaging and presence protocol (XMPP), Multimedia Messaging Service (MMS), Short Message Service (SMS), or any other suitable communications standards, protocols, and technologies.

In such embodiments, the example server 702 may transfer data to other devices, such as user device, over one or more networks via the network interface 708. For example, in some embodiments the example server 702 may receive requests for webpages and respond with the requested webpages (e.g., requests and responses using the hypertext transfer protocol (HTTP)). In some embodiments, the example server 702 may send notifications to a user device, such as via an asynchronous communication providing in a webpage, messages sent to a user device using a messaging protocol, emails sent to a user device using an email protocol, or other notifications.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described herein. It is to be understood that the forms shown and described herein are to be taken as examples of embodiments. Elements and materials may be substituted for those illustrated and described herein, parts and processes may be reversed or omitted, and certain features may be utilized independently, all as would be apparent to one skilled in the art after having the benefit of this description. Changes may be made in the elements described herein without departing from the spirit and scope of the disclosure as described in the following claims. Headings used herein are for organizational purposes only and are not meant to be used to limit the scope of the description.

What is claimed is:

1. A networking and recruiting system, comprising:
at least one server comprising a non-transitory computer-readable memory and a processor, the non-transitory computer-readable memory having executable computer code stored thereon, the executable computer code comprising instructions to cause the processor to perform operations comprising:
providing at least one webpage to a user device in response to a request for a webpage;
receiving candidate data and candidate skillsets associated with an employment candidate;
creating a candidate profile having the candidate data and skillsets;
storing the created candidate profile in a profile database;
determining, after providing the at least one webpage, a selection of dual role profiles;
upon determining that the selection comprises dual role profiles, perform operations comprising:
receiving employer data and employer skillsets associated with employment requirements of an employer;
creating a hiring manager profile having the employer data and employer skillsets; and
storing the created hiring manager profile in a profile database, wherein the created candidate profile and the created hiring manager profile are associated with the same user account.

2. The networking and recruiting system of claim 1, the operations comprising:
selecting a candidate profile, the selected candidate profile having a respective one or more employment candidate skillsets;
selecting a hiring manager profile, the hiring manager profile having a respective one or more employer skillsets;
determining whether at least one of the one or more employment candidate skillsets of the candidate profile match at least one of the one or more employer skillsets of the hiring manager profile;
associating the candidate profile with the hiring manager profile based on the determination.

3. The networking and recruiting system of claim 2, the operations comprising:
sending a notification to a user account associated with the hiring manager profile based on the determination, the notification identifying the candidate profile.

4. The networking and recruiting system of claim 1, the operations comprising:
selecting a candidate profile having a respective one or more employment candidate skillsets;
selecting a hiring manager profile, the hiring manager profile having one or more employer skillsets;
identifying a matching threshold associated with the hiring manager profile, the matching threshold defining a minimum number or percentage of skillsets;
determining whether at least the minimum number or percentage of the one or more employer skillsets of the candidate profile match the one or more employer skillsets of the hiring manager profile; and
associating the candidate profile with the hiring manager profile based on the determination.

5. The networking and recruiting system of claim 1, the operations comprising:
after creating the candidate profile having the candidate data and skillsets, performing operations further comprising:
determining a selection of a passive candidate profile;
identifying the created candidate profile as a passive candidate profile;
identifying the candidate data as private data of the candidate profile, where the private data is only viewable by another user of the networking and recruiting system upon a grant of permission to another user account by a user account associated with the candidate profile; and
storing the candidate skillets as public data of the candidate profile, wherein the public data is viewable by other users of the networking and recruiting system.

6. The networking and recruiting system of claim 5, the operations comprising:
determining that one or more employment candidate skillets of the passive candidate profile matches one or more skillsets of a selected hiring manager profile; and
sending a notification to a user account identified with the hiring manager profile based on the determination, the notification comprising the public data of the passive candidate profile or comprising a link to the public data of the passive candidate profile.

7. The networking and recruiting system of claim 6, the operations comprising:
receiving, from the user account identified with the hiring manager profile, a selection to send a request to a user account identified with the passive candidate profile, the request comprising a request to grant permission to view the private data of the passive candidate profile; and
sending the request to the user account identified with the passive candidate profile.

8. The networking and recruiting system of claim 7, the operations comprising:
receiving, from the user account identified with the passive candidate profile, a grant of permission to the user account associated with the hiring manage profile to view the private data of the passive candidate profile.

9. A non-transitory computer-readable media having executable computer code stored thereon, the executable computer code comprising instructions to cause a processor to perform operations comprising:
providing at least one webpage to a user device in response to a request for a webpage;
receiving candidate data and candidate skillsets associated with an employment candidate;
creating a candidate profile having the candidate data and skillsets;
storing the created candidate profile in a profile database;
determining, after providing the at least one webpage, a selection of dual role profiles; and
upon determining that the selection comprises dual role profiles, perform operations comprising:
receiving employer data and employer skillsets associated with employment requirements of an employer;
creating a hiring manager profile having the employer data and employer skillsets; and
storing the created hiring manager profile in the profile database, wherein the created candidate profile and the created hiring manager profile are associated with the same user account.

10. The non-transitory computer-readable media of claim 9, the operations comprising:
selecting a candidate profile, the selected candidate profile having a respective one or more employment candidate skillsets;
selecting a hiring manager profile, the hiring manager profile having a respective one or more employer skillsets;
determining whether at least one of the one or more employment candidate skillsets of the candidate profile match at least one of the one or more employer skillsets of the hiring manager profile; and
associating the candidate profile with the hiring manager profile based on the determination.

11. The non-transitory computer-readable media of claim 9, the operations comprising:
sending a notification to a user account associated with the hiring manager profile based on the determination, the notification identifying the candidate profile.

12. The non-transitory computer-readable media of claim 9, the operations comprising:
after creating the candidate profile having the candidate data and skillsets, performing operations further comprising:
determining a selection of a passive candidate profile;
identifying the created candidate profile as a passive candidate profile;
identifying the candidate data as private data of the candidate profile, where the private data is only viewable by another user of the networking and recruiting system upon a grant of permission to another user account by a user account associated with the candidate profile; and
storing the candidate skillets as public data of the candidate profile, wherein the public data is viewable by other users of the networking and recruiting system.

13. The non-transitory computer-readable media of claim 12, the operations comprising:
determining that one or more employment candidate skillets of the passive candidate profile matches one or more skillsets of a selected hiring manager profile; and
sending a notification to a user account identified with the hiring manager profile based on the determination, the notification comprising the public data of the passive candidate profile or comprising a link to the public data of the passive candidate profile.

14. The non-transitory computer-readable media of claim 13, the operations comprising:
receiving, from the user account identified with the hiring manager profile, a selection to send a request to a user account identified with the passive candidate profile, the request comprising a request to grant permission to view the private data of the passive candidate profile; and
sending the request to the user account identified with the passive candidate profile.

15. The non-transitory computer-readable media of claim 14, the operations comprising:
receiving, from the user account identified with the passive candidate profile, a grant of permission to the user account associated with the hiring manage profile to view the private data of the passive candidate profile.

16. A networking and recruiting system, comprising:
at least one server comprising a non-transitory computer-readable memory and a processor, the non-transitory computer-readable memory having executable computer code stored thereon, the executable computer code comprising instructions to cause the processor to perform operations comprising:
providing at least one webpage to a user device in response to a request for a webpage;
receiving candidate data and candidate skillsets associated with an employment candidate;
creating a candidate profile having the candidate data and skillsets;
storing the created candidate profile in a profile database;
determining, after providing the at least one webpage, a selection of dual role profiles; and
upon determining that the selection comprises dual role profiles, perform operations comprising:
receiving employer data and employer skillsets associated with employment requirements of an employer;
creating a hiring manager profile having the employer data and employer skillsets; and
storing the created hiring manager profile in the profile database, wherein the created candidate profile and the created hiring manager profile are associated with the same user account.

17. The networking and recruiting system of claim 16, the operations comprising:
determining a selection of the first candidate profile as a passive candidate profile;
identifying the first candidate data as private data of the first candidate profile, where the private data is only viewable by another user of the networking and recruiting system upon a grant of permission to another user account by the first user account; and
storing the candidate skillets as public data of the first candidate profile, wherein the public data is viewable by other users of the networking and recruiting system.

18. The networking and recruiting system of claim 17, the operations comprising:
determining that employment candidate skillets of the passive candidate profile match employer skillsets of a selected hiring manager profile; and
sending a notification to a third user account identified with the selected hiring manager profile based on the determination, the notification comprising the public data of the passive candidate profile or a link to the public data of the passive candidate profile.

19. The networking and recruiting system of claim 18, the operations comprising:
receiving, from the third user account, a selection to send a request to the first user account, the request comprising a request to grant permission to view the private data of the passive candidate profile; and
sending the request to the first user account.

20. The networking and recruiting system of claim 19, the operations comprising:
receiving, from the first user account, a grant of permission to the third user account associated to view the private data of the passive candidate profile.
